(19) United States
(12) Patent Application Publication
(10) Pub. No.: US 2024/0332733 A1
(43) Pub. Date: Oct. 3, 2024

(54) ALL SOLID BATTERY

(71) Applicant: TAIYO YUDEN CO., LTD., Tokyo (JP)

(72) Inventors: Chie KAWAMURA, Tokyo (JP); Hajime HASEGAWA, Tokyo (JP)

(73) Assignee: TAIYO YUDEN CO., LTD., Tokyo (JP)

(21) Appl. No.: 18/604,883

(22) Filed: Mar. 14, 2024

(30) Foreign Application Priority Data
Mar. 29, 2023 (JP) 2023-054166
Jun. 19, 2023 (JP) 2023-100065

(51) Int. Cl. H01M 50/431; H01M 4/62; H01M 10/0562; H01M 50/449

(52) U.S. Cl. CPC H01M 50/431; H01M 4/625; H01M 10/0562; H01M 50/449

(57) ABSTRACT

An all solid battery includes a solid electrolyte layer, and electrode layers that are provided on both main faces of the solid electrolyte layer and include an electrode active material and a fibrous conductive auxiliary agent. In cross sections of the electrode layers, an average diameter of the conductive auxiliary agent is 2 nm or more and 150 nm or less, an area ratio occupied by the conductive auxiliary agent is 0.5% or more and 5.0% or less, and an area ratio occupied by the electrode active material is 28% or more and less than 80%. A thickness of the solid electrolyte layer is 5 μm or more and 20 μm or less.

### CROSS-REFERENCE TO RELATED APPLICATION

This application is based upon and claims the benefit of priority of the prior Japanese Patent Application No. 2023-054166, filed on Mar. 29, 2023 and the prior Japanese Patent Application No. 2023-100065, filed on Jun. 19, 2023, the entire contents of which are incorporated herein by reference.

### FIELD

A certain aspect of the present invention relates to an all solid battery.

### BACKGROUND

All-solid batteries using oxide-based solid electrolytes are expected to be a technology that can provide safe secondary batteries that do not cause ignition or toxic gas generation, which are concerns with organic electrolytes, sulfide-based solid electrolytes or the like (For example, see Japanese Patent Application Publication No. 2021-034202 hereinafter referred to as Patent Document 1, International Publication No. 2014/042083 hereinafter referred to as Patent Document 2, and International Publication No. 2021/095757 hereinafter referred to as Patent Document 3).

### SUMMARY OF THE INVENTION

According to an aspect of the present invention, there is provided an all solid battery including: a solid electrolyte layer; and electrode layers that are provided on both main faces of the solid electrolyte layer and include an electrode active material and a fibrous conductive auxiliary agent, wherein, in cross sections of the electrode layers, an average diameter of the conductive auxiliary agent is 2 nm or more and 150 nm or less, an area ratio occupied by the conductive auxiliary agent is 0.5% or more and 5.0% or less, and an area ratio occupied by the electrode active material is 28% or more and less than 80%, and wherein a thickness of the solid electrolyte layer is 5 μm or more and 20 μm or less.

According to another aspect of the present invention, there is provided an all solid battery including: a solid electrolyte layer; and electrode layers that are provided on both main faces of the solid electrolyte layer and include an electrode active material and a carbon-based conductive auxiliary agent, wherein, in cross sections of the electrode layers, an average diameter of the conductive auxiliary agent is 5 nm or more and less than 150 nm, and a GD ratio of the conductive auxiliary agent is 0.5 or more and 20 or less, wherein, in the cross sections, an area ratio occupied by the conductive auxiliary agent is more than 0.5% and 10% or less, and wherein a thickness of the solid electrolyte layer is 5 μm or more and 20 μm or less.

### BRIEF DESCRIPTION OF THE DRAWINGS

FIG. 1 illustrates a schematic cross section of a basic structure of an all solid battery;

FIG. 2 illustrates a cross section;

FIG. 3 illustrates a schematic cross section of a stacked all solid battery in which battery units are stacked;

FIG. 4 illustrates a schematic cross section of a stacked all solid battery in which battery units are stacked;

FIG. 5A and FIG. 5B are perspective views illustrating a conductive auxiliary agent;

FIG. 5C is a diagram illustrating a stacked cross section of a positive electrode layer;

FIG. 6 illustrates a flowchart of a manufacturing method of an all solid battery; and

FIG. 7A and FIG. 7B illustrate a stacking process.

### DETAILED DESCRIPTION

In Patent Document 1, plate-shaped carbon is used. Plate-shaped carbon tends to be parallel to the stacking direction, and there is a possibility that the ion conduction path in the stacking direction (between the positive electrode and the negative electrode) may be inhibited. Furthermore, the volume ratio of the conductive auxiliary agent is high, and a large amount of the conductive auxiliary agent that does not contribute to the capacity is included. Therefore, there is a possibility that high capacity will not be achieved.

In Patent Document 2, fibrous carbon is used. However, the VGCF used in Patent Document 2 has a relatively thick fiber diameter of 150 nm, and there is a risk that VGCF will break through the solid electrolyte sheet during molding, resulting in short-circuit defects.

The structure, in which thin layers of solid electrolyte and internal electrodes are alternately stacked, is expected to achieve both high battery capacity and high responsiveness. Chip-type small all solid batteries are required to have higher capacity with limited component volume.

It has been considered to use a carbon material as a conductive auxiliary agent for the electrode layer. However, since the conductive auxiliary agent does not contribute to the battery capacity, increasing the amount of the conductive auxiliary agent to improve conductivity may result in poor battery operation. Furthermore, if a carbon material is used, the yield may decrease.

A description will be given of an embodiment with reference to the accompanying drawings.

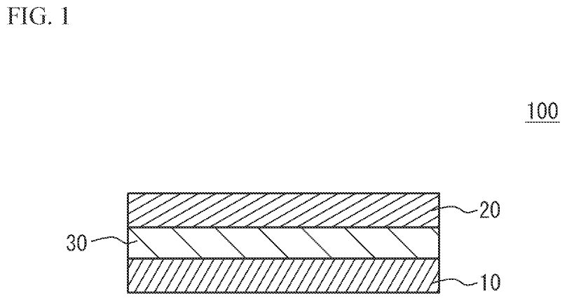

(First Embodiment) FIG. 1 illustrates a schematic cross section of a basic structure of an all solid battery 100 in accordance with an embodiment. As illustrated in FIG. 1, the all solid battery 100 has a structure in which a positive electrode layer 10 and a negative electrode layer 20 sandwich a solid electrolyte layer 30. The positive electrode layer 10 is provided on a first main face of the solid electrolyte layer 30. The negative electrode layer 20 is provided on a second main face of the solid electrolyte layer 30. For example, the positive electrode layer 10, the negative electrode layer 20 and the solid electrolyte layer 30 have a sintered body which is formed by sintering powder materials.

A main component of the solid electrolyte layer 30 is solid electrolyte having ion conductivity. The solid electrolyte of the solid electrolyte layer 30 is an oxide-based solid electrolyte having lithium ion conductivity. The solid electrolyte is phosphoric acid salt-based electrolyte having a NASICON crystal structure. The phosphoric acid salt-based solid electrolyte having the NASICON crystal structure has a high conductivity and is stable in normal atmosphere. The phosphoric acid salt-based solid electrolyte is, for example, such as a salt of phosphoric acid including lithium. The phosphoric acid salt is not limited. For example, the phosphoric acid salt is such as composite salt of phosphoric acid with Ti (for example LiTi₂(PO₄)₃). Alternatively, at least a part of Ti may be replaced with a transition metal of which a valence is four, such as Ge, Sn, Hf, or Zr. In order to increase an amount of Li, a part of Ti may be replaced with a transition metal of which a valence is three, such as Al, Ga, In, Y or La. In concrete, the phosphoric acid salt including lithium and having the NASICON structure is Li₁₊ₓAlₓGe₂₋ₓ(PO₄)₃, Li₁₊ₓAlₓZr₂₋ₓ (PO₄)₃, Li₁₊ₓAlₓT₂₋ₓ(PO₄)₃ or the like. For example, it is preferable that Li—Al—Ge—PO₄-based material, to which a transition metal included in the phosphoric acid salt having the olivine type crystal structure included in the positive electrode layer 10 and the negative electrode layer 20 is added in advance, is used. For example, when the positive electrode layer 10 and the negative electrode layer 20 include phosphoric acid salt including Co and Li, it is preferable that the solid electrolyte layer 30 includes Li—Al—Ge—PO₄-based material to which Co is added in advance. In this case, it is possible to suppress solving of the transition metal included in the electrode active material into the electrolyte. When the positive electrode layer 10 and the negative electrode layer 20 include phosphoric acid salt including Li and a transition metal other than Co, it is preferable that the solid electrolyte layer 30 includes Li—Al—Ge—PO₄-based material in which the transition metal is added in advance.

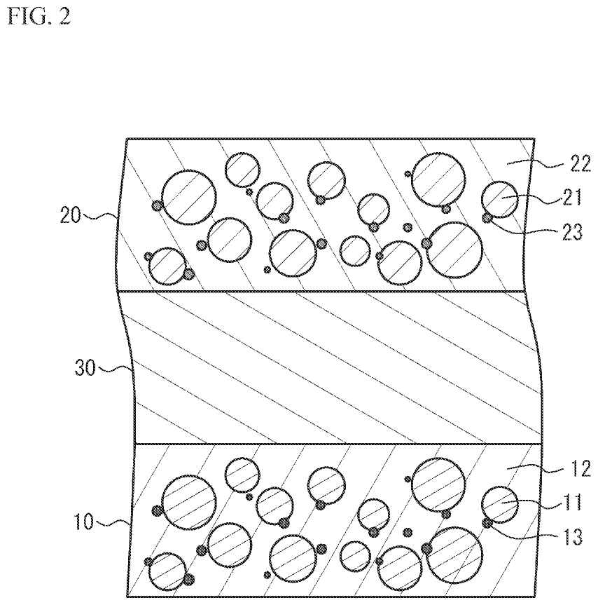

As illustrated in FIG. 2, the positive electrode layer 10 has a structure in which an electrode active material 11, a solid electrolyte 12, a conductive auxiliary agent 13 and so on are dispersed. The negative electrode layer 20 has a structure in which an electrode active material 21, a solid electrolyte 22, a conductive auxiliary agent 23 and so on are dispersed. Since the positive electrode layer 10 includes the electrode active material 11 and the negative electrode layer 20 includes the electrode active material 21, the all solid battery 100 can be used as a secondary battery. Since the positive electrode layer 10 includes the solid electrolyte 12 and the negative electrode layer 20 includes the solid electrolyte 22, ionic conductivity is obtained in the positive electrode layer 10 and the negative electrode layer 20. Since the positive electrode layer 10 includes the conductive auxiliary agent 13 and the negative electrode layer 20 includes the conductive auxiliary agent 23, the positive electrode layer 10 and the negative electrode layer 20 have electrical conductivity.

The electrode active material 11 is, for example, an electrode active material having an olivine type crystal structure. It is preferable that the negative electrode layer 20 also includes the electrode active material having an olivine type crystal structure. The electrode active material is such as phosphoric acid salt including a transition metal and lithium. The olivine type crystal structure is a crystal of natural olivine. It is possible to identify the olivine type crystal structure, by using X-ray diffraction.

For example, LiCoPO₄ including Co may be used as a typical example of the electrode active material having the olivine type crystal structure. Other salts of phosphoric acid, in which Co acting as a transition metal is replaced to another transition metal in the above-mentioned chemical formula, may be used. A ratio of Li or PO₄ may fluctuate in accordance with a valence. It is preferable that Co, Mn, Fe, Ni or the like is used as the transition metal. As a positive electrode active material containing Co and P, LiCo₂P₃O₁₀, LizCoP₂O₇, Li₆Co₅(P₂O₇)₄ or the like can also be used.

For example, when only the positive electrode layer 10 includes the electrode active material having the olivine type crystal structure, the electrode active material acts as the positive electrode active material. When the negative electrode layer 20 also includes an electrode active material having the olivine type crystal structure, discharge capacity may increase and an operation voltage may increase because of electric discharge, in the negative electrode layer 20 acting as the negative electrode. The function mechanism is not completely clear. However, the mechanism may be caused by partial solid-phase formation together with the negative electrode active material.

When both the positive electrode layer 10 and the negative electrode layer 20 include an electrode active material having the olivine type crystal structure, the electrode active material of each of the positive electrode layer 10 and the negative electrode layer 20 may have a common transition metal. Alternatively, the a transition metal of the electrode active material of the positive electrode layer 10 may be different from that of the negative electrode layer 20. The positive electrode layer 10 and the negative electrode layer 20 may have only single type of transition metal. The positive electrode layer 10 and the negative electrode layer 20 may have two or more types of transition metal. It is preferable that the positive electrode layer 10 and the negative electrode layer 20 have a common transition metal. It is more preferable that the electrode active materials of the both electrode layers have the same chemical composition. When the positive electrode layer 10 and the negative electrode layer 20 have a common transition metal or a common electrode active material of the same composition, similarity between the compositions of the both electrode layers increases. Therefore, even if terminals of the all solid battery 100 are connected in a positive/negative reversed state, the all solid battery 100 can be actually used without malfunction, in accordance with the usage purpose.

The negative electrode layer 20 acts as a negative electrode layer when including the electrode active material 21. When only one of the electrode layers includes the negative electrode active material, it is clarified that the one of the electrode layers acts as a negative electrode and the other acts as a positive electrode. Both of the electrode layers may include the known material as the negative electrode active material. Conventional technology of secondary batteries may be applied to the negative electrode active material. For example, titanium oxide, lithium-titanium complex oxide, lithium-titanium complex salt of phosphoric acid salt, a carbon, a vanadium lithium phosphate.

The solid electrolyte 12 and the solid electrolyte 22 are not particularly limited as long as they are oxide-based solid electrolytes that have ionic conductivity. The solid electrolyte 12 and the solid electrolyte 22 are, for example, oxide-based solid electrolytes having lithium ion conductivity. The solid electrolyte is, for example, a phosphate solid electrolyte having a NASICON structure. The phosphate solid electrolyte is, for example, a phosphate containing lithium. The phosphate is not particularly limited, but includes, for example, a composite lithium phosphate salt with Ti (for example, LiTi₂(PO₄)₃). Alternatively, Ti can be partially or completely replaced with a tetravalent transition metal such as Ge, Sn, Hf, or Zr. Further, in order to increase the Li content, a portion of the metal may be replaced with a trivalent transition metal such as Al, Ga, In, Y, or La. More specifically, examples include Li₁₊ₓAlₓGe₂₋ₓ(PO₄)₃, Li₁₊ₓAlₓZr₂₋ₓ(PO₄)₃, or Li₁₊ₓAlₓTi₂₋ₓ(PO₄)₃. The solid electrolyte 12 and the solid electrolyte 22 can be, for example, the same as the solid electrolyte that is the main component of the solid electrolyte layer 30. Alternatively, when the electrode active material contains Co and P, it is preferable that the solid electrolytes 12 and 22 contain Co. Although the detailed mechanism is unknown, by including Co during co-firing, the oxidation resistance stability of the solid electrolyte tends to improve, thereby easily ensuring cycle stability.

A carbon material is used as the conductive auxiliary agents 13 and 23. A metal may be used as the conductive auxiliary agents 13 and 23. Pd, Ni, Cu, or Fe, or an alloy thereof may be used as the metal of the conductive auxiliary agent.

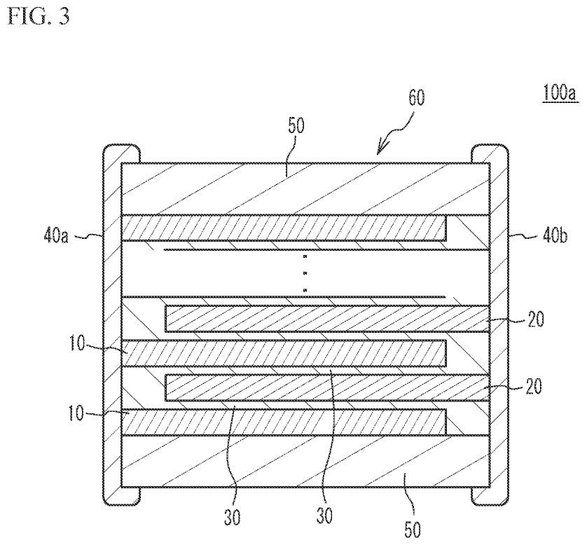

FIG. 3 is a partial cross-sectional perspective view of a stacked all solid battery 100a in which a plurality of battery units are stacked. The all solid battery 100a includes a multilayer chip 60 having a substantially rectangular parallelepiped shape. In the multilayer chip 60, a first external electrode 40a and a second external electrode 40b are provided so as to be in contact with two side faces, which are two of the four faces other than the upper face and the lower face at the ends in the stacking direction. The two side faces may be two adjacent side faces or may be two side faces facing each other. In this embodiment, it is assumed that the first external electrode 40a and the second external electrode 40b are provided so as to be in contact with the two side faces (hereinafter referred to as two end faces) facing each other.

In the following description, the same numeral is added to each member that has the same composition range, the same thickness range and the same particle distribution range as that of the all solid battery 100. And, a detail explanation of the same member is omitted.

In the all solid battery 100a, the plurality of positive electrode layers 10 and the plurality of negative electrode layers 20 are alternately stacked with the solid electrolyte layers 30 in between. The number of the positive electrode layers 10 and the number of the negative electrode layers 20 may be the same as each other. One of the numbers may be larger than the other by one layer. The edges of the plurality of positive electrode layers 10 are exposed to the first end face of the multilayer chip 60 and are not exposed to the second end face. The edges of the plurality of negative electrode layers 20 are exposed to the second end face of the multilayer chip 60 and are not exposed to the first end face. Thereby, the positive electrode layer 10 and the negative electrode layer 20 are alternately electrically connected to the first external electrode 40a and the second external electrode 40b. Note that the solid electrolyte layer 30 extends from the first external electrode 40a to the second external electrode 40b. In this way, the all solid battery 100a has a structure in which a plurality of battery units are stacked.

A cover layer 50 is stacked on the upper face (in FIG. 3, the upper face of the uppermost one of the positive electrode layers 10) of the multilayer body of the positive electrode layers 10, the solid electrolyte layers 30, and the negative electrode layers 20. Another cover layer is stacked on the lower face (in FIG. 3, the lower face of the lowermost one of the positive electrode layers 10) of the multilayer body. The cover layer 50 is mainly composed of an inorganic material (Al₂O₃, ZrO₂, TiO₂ or the like) containing Al, Zr, Ti or the like, for example. The cover layer 50 may contain the main component of the solid electrolyte layer 30 as a main component. The cover layer 50 is a sintered body.

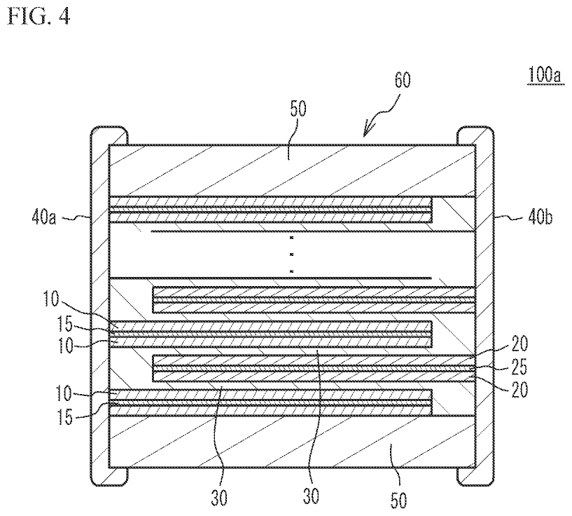

Each of the positive electrode layer 10 and the negative electrode layer 20 may include a current collector layer. For example, as illustrated in FIG. 4, a first current collector layer 15 may be provided within the positive electrode layer 10. Further, a second current collector layer 25 may be provided within the negative electrode layer 20. The first current collector layer 15 and the second current collector layer 25 have a conductive material as a main component. For example, metal, carbon, or the like can be used as the conductive material for the first current collector layer 15 and the second current collector layer 25. By connecting the first current collector layer 15 to the first external electrode 40a and connecting the second current collector layer 25 to the second external electrode 40b, current collection efficiency is improved.

As described above, the positive electrode layer 10 and the negative electrode layer 20 contain a conductive auxiliary agent from the viewpoint of conductivity. For example, it is possible to use a plate-shaped conductive auxiliary agent as the conductive auxiliary agent. However, the plate-shaped conductive auxiliary agent tends to be parallel to the stacking direction, and there is a possibility that the ion conduction path between the positive electrode layer 10 and the negative electrode layer 20 may be inhibited. In addition, the volume ratio of the conductive auxiliary agent becomes high, and there is a possibility that high capacity cannot be achieved. Therefore, it is possible to use a fibrous conductive auxiliary agent. However, since the conductive auxiliary agent having a large fiber diameter is thick, there is a risk that the conductive auxiliary agent will break through the solid electrolyte sheet during forming, causing short-circuit defects.

Therefore, the all solid batteries 100 and 100a according to the present embodiment have a configuration that can achieve both favorable battery operation and improved yield.

Specifically, a fibrous conductive material is used as the conductive auxiliary agents 13 and 23. By using the fibrous conductive material, the width of the conductive auxiliary agents 13 and 23 becomes smaller, so that the ionic conduction path between the positive electrode layer 10 and the negative electrode layer 20 is achieved compared to the case where plate-like carbon is used.

Next, in the stacked cross section of the positive electrode layer 10, the average diameter of the conductive auxiliary agent 13 is 2 nm or more and less than 150 nm, the area ratio occupied by the conductive auxiliary agent 13 is 0.5% or more and 5.0% or less, and the area ratio occupied by the electrode active material 11 is 28% or more and less than 80%. Further, in the cross section of the negative electrode layer 20, the average diameter of the conductive auxiliary agent 23 is 2 nm or more and less than 150 nm, the area ratio occupied by the conductive auxiliary agent 23 is 0.5% or more and 5.0% or less, and the area ratio occupied by the electrode active material 21 is 28% or more and less than 80%. Further, the thickness of the solid electrolyte layer 30 is 5 μm or more and 20 μm or less. Note that the stacked cross section here is a cross section that includes the stacking direction, and is a cross section formed by the stacking direction and the direction in which the first external electrode 40a and the second external electrode 40b face each other.

According to this configuration, since the average diameter of the conductive auxiliary agents 13 and 23 is small, less than 150 nm, the conductive auxiliary agents 13 and 23 become thin and flexible. This prevents the solid electrolyte green sheet before firing from being pierced by the conductive auxiliary agents 13 and 23, making it possible to suppress short-circuit defects. On the other hand, since the average diameter of the conductive auxiliary agents 13 and 23 is 2 nm or more, sufficient conductivity can be achieved.

Next, sufficient conductivity can be obtained by setting the area ratio that the conductive auxiliary agent 13 occupies in the positive electrode layer 10 and the area ratio that the conductive auxiliary agent 23 occupies in the negative electrode layer 20 to be 0.5% or more. Thereby, sufficient rate characteristics can be obtained and sufficient battery capacity can be obtained. On the other hand, by setting the area ratio occupied by the conductive auxiliary agents 13 and 23 to 5.0% or less, the content of the electrode active material and the solid electrolyte can be ensured.

Next, by setting the area ratio occupied by the electrode active material 11 in the positive electrode layer 10 and the area ratio occupied by the electrode active material 21 in the negative electrode layer 20 to 28% or more, the content of the electrode active material can be ensured. This ensures battery capacity. On the other hand, by setting the area ratio occupied by the electrode active material 11 in the positive electrode layer 10 and the area ratio occupied by the electrode active material 21 in the negative electrode layer 20 to less than 80%, the content of the solid electrolyte can be ensured.

Next, by setting the thickness of the solid electrolyte layer 30 to 5 μm or more, a sufficient thickness of the solid electrolyte layer can be ensured, and break-through by the conductive auxiliary agents 13 and 23 can be suppressed. Thereby, short circuit defects can be suppressed. On the other hand, rate characteristics are ensured by setting the thickness of the solid electrolyte layer 30 to 20 μm or less.

From the above, the all solid batteries 100 and 100a according to the present embodiment can achieve both favorable battery operation and improved yield.

In addition, from the viewpoint of making the conductive auxiliary agents 13 and 23 sufficiently thin, the average diameter of the conductive auxiliary agents 13 and 23 in the stacked cross section is preferably 130 nm or less, more preferably 80 nm or less.

On the other hand, from the viewpoint of achieving sufficient conductivity or achieving sufficient thermal stability, the average diameter of the conductive auxiliary agents 13 and 23 in the stacked cross section is preferably 5 nm or more, and preferably 8 nm or more.

In addition, from the viewpoint of achieving sufficient conductivity, in the stacked cross section, the area ratio that the conductive auxiliary agent 13 occupies in the positive electrode layer 10 and the area ratio that the conductive auxiliary agent 23 occupies in the negative electrode layer 20 are 0.6% or more, and preferably 0.7% or more.

On the other hand, from the viewpoint of ensuring the content of the electrode active material and the solid electrolyte, in the stacked cross section, the area ratio that the conductive auxiliary agent 13 occupies in the positive electrode layer 10 and the area ratio that the conductive auxiliary agent 23 occupies in the negative electrode layer 20 are preferably 4.5% or less, and more preferably 4% or less.

In addition, from the viewpoint of ensuring the content of the electrode active material, in the stacked cross section, the area ratio that the electrode active material 11 occupies in the positive electrode layer 10 and the area ratio that the electrode active material 21 occupies in the negative electrode layer 20 are preferably 30% or more and more preferably 40% or more.

On the other hand, from the viewpoint of ensuring the solid electrolyte content, the area ratio that the electrode active material 11 occupies in the positive electrode layer 10 and the area ratio that the electrode active material 21 occupies in the negative electrode layer 20 are preferably 75% or less, and more preferably 70% or less.

From the viewpoint of suppressing penetration by the conductive auxiliary agents 13 and 23, the thickness of the solid electrolyte layer 30 is preferably 6 μm or more, and more preferably 7 μm or more.

On the other hand, from the viewpoint of ensuring rate characteristics, the thickness of the solid electrolyte layer 30 is preferably 19 μm or less, and more preferably 18 μm or less.

The material of the conductive auxiliary agents 13 and 23 is not particularly limited as long as the conductive auxiliary agents 13 and 23 have conductivity, but are preferably a carbon material. Since the carbon material is soft, it is possible to suppress penetration into the solid electrolyte layer 30. For example, it is preferable to use carbon nanotubes or the like as the conductive auxiliary agents 13 and 23. Since the carbon nanotubes have a hollow fiber shape and are soft, it is possible to suppress the carbon nanotubes from penetrating the solid electrolyte layer 30.

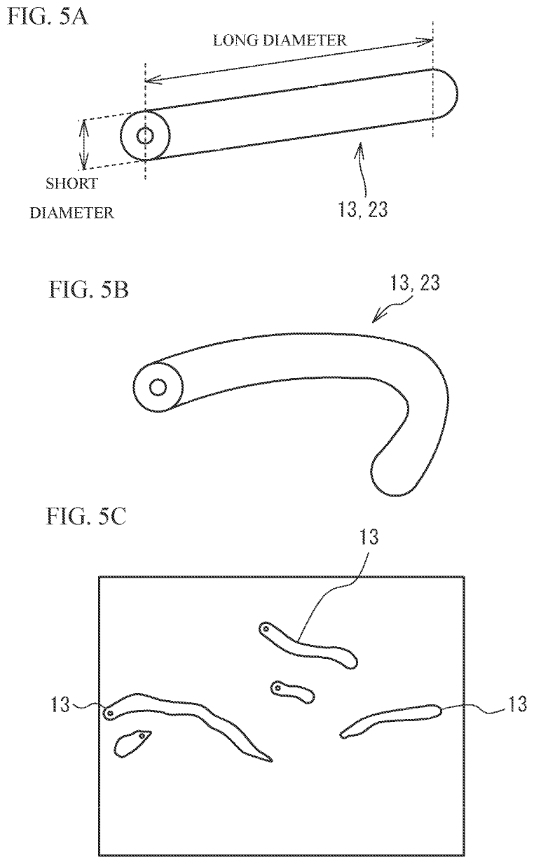

FIG. 5A is a perspective view illustrating the conductive auxiliary agents 13 and 23. As illustrated in FIG. 5A, the conductive auxiliary agents 13 and 23 have a fibrous shape and have a major axis and a minor axis. The major axis is a longitudinal direction. The minor axis a short axis. The aspect ratio (major axis:minor axis), which is the ratio of the major axis to the minor axis, is preferably 100:1 to 3000:1, more preferably 125:1 to 1000:1, and more preferably 150:1 to 500:1.

In order to ensure a sufficient conductive distance, the total length of the conductive auxiliary agents 13 and 23 is preferably 1.5 μm or more, more preferably 2.5 μm or more, and even more preferably 5 μm or more.

Note that the conductive auxiliary agents 13 and 23 do not need to extend linearly in the positive electrode layer 10 and the negative electrode layer 20, and may be curved as illustrated in FIG. 5B. Further, when using carbon nanotubes, the hollow portion may be a void or may be filled with another member.

FIG. 5C is a diagram illustrating the stacked cross section of the positive electrode layer 10. The stacked cross section can be exposed by polishing the all solid batteries 100 and 100a. Furthermore, the stacked cross section can be observed using a SEM (scanning electron microscope) or the like. The average diameter of the conductive auxiliary agents 13 can be calculated by randomly observing 300 number of the conductive auxiliary agents 13, measuring the shortest part, and taking the average value. The average diameter of the conductive auxiliary agents 23 in the negative electrode layer 20 can also be measured using the same procedure.

The thickness of the solid electrolyte layer 30 can be measured by observing the stacked cross section of the all solid batteries 100 and 100a with an SEM, measuring the thickness at 10 different points in one layer, and deriving the average value.

(Second Embodiment) In this embodiment, a relatively flexible carbon-based material is used as the conductive auxiliary agents 13 and 23. In addition to the carbon-based conductive auxiliary agents 13 and 23, a metal may also be used. Examples of the metal of the conductive auxiliary agents include Pd, Ni, Cu, Fe, or alloys containing these. Hereinafter, points different from the first embodiment will be explained.

As described above, the positive electrode layer 10 and the negative electrode layer 20 contain a conductive auxiliary agent from the viewpoint of conductivity. However, if the conductivity of the conductive auxiliary agent is low, a predetermined amount of the conductive auxiliary agent is required to provide the positive electrode layer 10 and the negative electrode layer 20 with good conductivity. However, when the content of the conductive auxiliary agent that does not contribute to the battery capacity increases, the battery capacity in the positive electrode layer 10 and the negative electrode layer 20 decreases.

Therefore, in this embodiment, a lower limit is set for a GD ratio of the conductive auxiliary agents 13 and 23. Here, the GD ratio of the conductive auxiliary agents 13 and 23 can be measured by performing Raman spectroscopy on the conductive auxiliary agents 13 and 23. Specifically, measurements are performed under the conditions of an excitation wavelength of 487.88 nm and a grating L600, and the peak intensity ID in the range of 1300 cm⁻¹ to 1400 cm⁻¹ and the peak intensity IG in the range of 1500 cm⁻¹ to 1600 cm⁻¹ are measured, and the ratio (IG/ID) is taken as the GD ratio. In this embodiment, the GD ratio is set to 0.5 or more. Thereby, the conductivity of the conductive auxiliary agents 13 and 23 is improved, the content of the conductive auxiliary agent 13 in the positive electrode layer 10 can be suppressed, and the content of the conductive auxiliary agent 23 in the negative electrode layer 20 can be suppressed. Further, when the GD ratio is 0.5 or more, the thermal stability of the conductive auxiliary agents 13 and 23 improves, so even if the all solid battery 100 is formed by high-temperature firing, the positive electrode layer 10 and the negative electrode layer 20 achieve high conductivity.

On the other hand, when the GD ratio of the conductive auxiliary agents 13 and 23 is high, the deformation of the positive electrode layer 10 and the negative electrode layer 20 does not follow the deformation of the solid electrolyte layer 30 during firing, and cavities are formed in the positive electrode layer 10 and the negative electrode layer 20, and the yield of the all solid batteries 100 and 100a may decrease. Therefore, in this embodiment, an upper limit is set for the GD ratio of the conductive auxiliary agents 13 and 23. Specifically, the GD ratio of the conductive auxiliary agents 13 and 23 is set to 20 or less. This suppresses cavity formation in the positive electrode layer 10 and the negative electrode layer 20, and improves the yield of the all solid battery 100.

Next, if the average diameter of the conductive auxiliary agents 13 and 23 is large, the solid electrolyte green sheet before firing may be pierced by the conductive auxiliary agents 13 and 23. Therefore, an upper limit is set on the average diameter of the conductive auxiliary agents 13 and 23. In this embodiment, the average diameter of the conductive auxiliary agents 13 in the cross section of the positive electrode layer 10 is less than 150 nm, and the average diameter of the conductive auxiliary agent 23 in the cross section of the negative electrode layer 20 is less than 150 nm. For example, the above cross section may be a cross section including the stacking direction.

On the other hand, if the average diameter of the conductive auxiliary agents 13 and 23 is small, there is a risk that the conductive auxiliary agents 13 and 23 may not necessarily have sufficient electrical conductivity. Therefore, a lower limit is set for the average diameter of the conductive auxiliary agents 13 and 23. In this embodiment, the average diameter of the conductive auxiliary agent 13 in the cross section of the positive electrode layer 10 is set to 5 nm or more, and the average diameter of the conductive auxiliary agent 23 in the cross section of the negative electrode layer 20 is set to 5 nm or more.

Next, if the content of the conductive auxiliary agents 13 and 23 that do not contribute to battery capacity is large, there is a risk that sufficient battery capacity will not be obtained for the all solid batteries 100 and 100a. Therefore, an upper limit is set for the content of the conductive auxiliary agents 13 and 23. In this embodiment, the area ratio of the conductive auxiliary agent 13 in the cross section of the positive electrode layer 10 is 10% or less, and the area ratio of the conductive auxiliary agent 23 in the cross section of the negative electrode layer 20 is 10% or less.

On the other hand, if the content of the conductive auxiliary agents 13 and 23 is small, there is a possibility that sufficient conductivity cannot be obtained in the positive electrode layer 10 and the negative electrode layer 20. Therefore, a lower limit is set for the content of the conductive auxiliary agents 13 and 23. In this embodiment, the area ratio of the conductive auxiliary agent 13 in the cross section of the positive electrode layer 10 is set to a value exceeding 0.5%, and the area ratio of the conductive auxiliary agent 23 in the cross section of the negative electrode layer 20 is set to a value exceeding 0.5%.

Next, if the solid electrolyte layer 30 is thin, the solid electrolyte green sheet before firing may be pierced by the conductive auxiliary agents 13 and 23, causing a short circuit. Therefore, a lower limit is set for the thickness of the solid electrolyte layer 30. In this embodiment, the thickness of the solid electrolyte layer 30 is 0.5 μm or more.

On the other hand, if the solid electrolyte layer 30 is thick, the rate characteristics of the all solid batteries 100 and 100a may deteriorate, and the battery characteristics may deteriorate. Therefore, an upper limit is set on the thickness of the solid electrolyte layer 30. In this embodiment, the thickness of the solid electrolyte layer 30 is 20 μm or less.

As described above, the GD ratio of the conductive auxiliary agents 13 and 23 is 0.5 or more and 20 or less, the average diameter of the conductive auxiliary agent 13 in the cross section of the positive electrode layer 10 is 5 nm or more and less than 150 nm, and the average diameter of the conductive auxiliary agent 23 in the cross section of the negative electrode layer 20 is 5 nm or more and less than 150 nm, the area ratio of the conductive auxiliary agent 13 in the cross section of the positive electrode layer 10 is more than 0.5% and 10% or less, and the area ratio of the conductive auxiliary agent 23 in the cross section of the negative electrode layer 20 is more than 0.5% and 10% or less, and the thickness of the solid electrolyte layer 30 is 5 μm or more and 20 μm or less, thereby suppressing the ratio of the conductive auxiliary agent that does not contribute to the capacity and achieving favorable battery operation and improved yield.

From the viewpoint of increasing the conductivity of the conductive auxiliary agents 13 and 23, the GD ratio of the conductive auxiliary agents 13 and 23 is preferably 1.0 or more, and more preferably 2.0 or more. From the viewpoint of suppressing a decrease in yield of the all solid batteries 100 and 100a, the GD ratio of the conductive auxiliary agents 13 and 23 is preferably 16 or less, and more preferably 10 or less.

From the viewpoint of suppressing penetration into the solid electrolyte green sheet before firing, the average diameter of each of the conductive auxiliary agents 13 and 23 is preferably 130 nm or less, and more preferably 80 nm or less. In order to give the conductive auxiliary agents 13 and 23 sufficient conductivity, the average diameter of each of the conductive auxiliary agents 13 and 23 is preferably 5 nm or more, and more preferably 8 nm or more.

In order to provide the all solid batteries 100 and 100a with sufficient battery capacity, the area ratio of the conductive auxiliary agent 13 in the cross section of the positive electrode layer 10 and the area ratio of the conductive auxiliary agent 23 in the cross section of the negative electrode layer 20 are preferably 10% or less, and more preferably 8% or less. In order to provide sufficient conductivity to the positive electrode layer 10 and negative electrode layer 20, the area ratio of the conductive auxiliary agent 13 in the cross section of the positive electrode layer 10 and the area ratio of the conductive auxiliary agent 23 in the cross section of the negative electrode layer 20 are preferably 1% or more, and mores preferably 2% or more.

From the viewpoint of suppressing penetration of the solid electrolyte green sheet before firing, the thickness of the solid electrolyte layer 30 is preferably 6 μm or more, and more preferably 7 μm or more. From the viewpoint of suppressing rate characteristic deterioration of the all solid batteries 100 and 100a, the thickness of the solid electrolyte layer 30 is preferably 19 μm or less, and more preferably 18 μm or less.

The material of the conductive auxiliary agents 13 and 23 is not particularly limited as long as the material of the conductive auxiliary agents 13 and 23 is a carbon-based material, but is preferably a fibrous carbon material. In this case, since the width of the conductive auxiliary agents 13 and 23 becomes smaller, it is possible to secure an ion conduction path between the positive electrode layer 10 and the negative electrode layer 20 compared to the case where plate-shaped carbon is used. It is preferable to use carbon nanotubes or the like as the conductive auxiliary agents 13 and 23. Since the carbon nanotubes have a hollow fiber shape and are soft, it is possible to suppress the carbon nanotubes from penetrating the solid electrolyte layer 30. In particular, it is preferable to use multilayer carbon nanotubes as the conductive auxiliary agents 13 and 23.

In addition, from the viewpoint of ensuring the content of the electrode active material, in the stacked cross section, the area ratio that the electrode active material 11 occupies in the positive electrode layer 10 and the area ratio that the electrode active material 21 occupies in the negative electrode layer 20 are preferably 30% or more, and mores preferably 40% or more.

On the other hand, from the viewpoint of ensuring the solid electrolyte content, the area ratio that the electrode active material 11 occupies in the positive electrode layer 10 and the area ratio that the electrode active material 21 occupies in the negative electrode layer 20 are preferably 75% or less, and more preferably 70% or less.

Note that the conductive auxiliary agents 13 and 23 do not need to extend linearly in the positive electrode layer 10 and the negative electrode layer 20, and may be curved as illustrated in FIG. 5B. Further, when using carbon nanotubes, the hollow portion may be a void or may be filled with another member. In addition, when using a fibrous carbon material, it is preferable to have a particle diameter of 5 nm or more in order to realize sufficient thermal stability.

The area ratio of the conductive auxiliary agent 13 can be determined using, for example, image analysis software (ImageJ Fiji: Schneider, C. A., Rasband, W. S., Elieiri, K. W. “NIH Image to ImageJ: 25 years of image analysis.” Nature Methods 9, 671-675, (2012). The area ratio can be measured by determining the ratio of the cross-sectional area of the conductive auxiliary agent 13 to the total area of the SEM image. The area ratio of the conductive auxiliary agent 23 in the negative electrode layer 20 can also be measured using the same procedure.

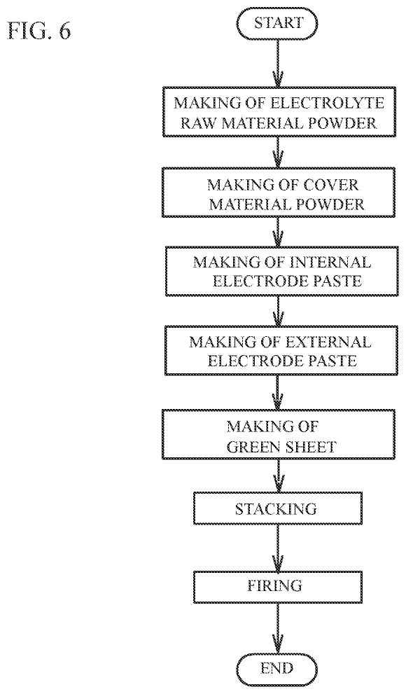

A description will be given of a manufacturing method of the all solid battery 100a described on the basis of FIG. 3. FIG. 6 illustrates a flowchart of the manufacturing method of the all solid battery 100a.

(Making process of raw material powder for solid electrolyte layer) A raw material powder for the solid electrolyte for the solid electrolyte layer 30 is made. For example, it is possible to make the raw material powder for the oxide-based solid electrolyte, by mixing raw material and additives and using solid phase synthesis method or the like. The resulting powder is subjected to dry grinding. Thus, a particle diameter of the resulting power is adjusted to a desired one. For example, it is possible to adjust the particle diameter to the desired diameter with use of planetary ball mill using ZrO₂ ball of 5 mm q.

(Making process of raw material powder for cover layer) A raw material powder of ceramics for the cover layer 50 is made. For example, it is possible to make the raw material powder for the cover layer, by mixing raw material and additives and using solid phase synthesis method or the like. The resulting powder is subjected to dry grinding. Thus, a particle diameter of the resulting power is adjusted to a desired one. For example, it is possible to adjust the particle diameter to the desired diameter with use of planetary ball mill using ZrO₂ ball of 5 mm ¢.

(Making process for electrode layer paste) Next, internal electrode pastes for making the positive electrode layer 10 and the negative electrode layer 20 described above are separately made. For example, an electrode active material and a solid electrolyte material are highly dispersed using a bead mill or the like to produce a ceramic paste consisting only of ceramic particles. The conductive auxiliary agents 13 and 23 are mixed into this ceramic paste. Since fibrous carbon is entangled, the conductive auxiliary agents 13 and 23 are dispersed using an ultrasonic homogenizer or a wet jet mill using a paste solvent and an appropriate dispersant. An electrode layer paste can be prepared by mixing the ceramic paste, the dispersion of the conductive auxiliary agents 13 and 23, and the binder.

The additive of the internal electrode paste includes sintering assistant. The sintering assistant includes one or more of glass components such as Li—B—O-based compound, Li—Si—O-based compound, Li—C—O-based compound, Li—S—O-based compound and Li—P—O-based compound.

(Making process of external electrode paste) Next, an external electrode paste for manufacturing the first external electrode 40a and the second external electrode 40b described above is made. For example, a paste for external electrodes can be obtained by uniformly dispersing a conductive material, glass frit, binder, plasticizer and so on in water or an organic solvent.

(Making process of solid electrolyte green sheet) By uniformly dispersing the raw material powder for the solid electrolyte layer in an aqueous or organic solvent together with a binder, dispersant, plasticizer and so on and performing wet pulverization, a solid electrolyte slurry having a desired average particle size can be made. At this time, a bead mill, a wet jet mill, various kneaders, a high-pressure homogenizer, or the like can be used, and it is preferable to use a bead mill from the viewpoint of being able to adjust the particle size distribution and perform dispersion at the same time. A binder is added to the obtained solid electrolyte slurry to obtain a solid electrolyte paste. A solid electrolyte green sheet 51 can be formed by applying the obtained solid electrolyte paste. The coating method is not particularly limited, and a slot die method, reverse coating method, gravure coating method, bar coating method, doctor blade method, or the like can be used. The particle size distribution after wet pulverization can be measured using, for example, a laser diffraction measuring device using a laser diffraction scattering method.

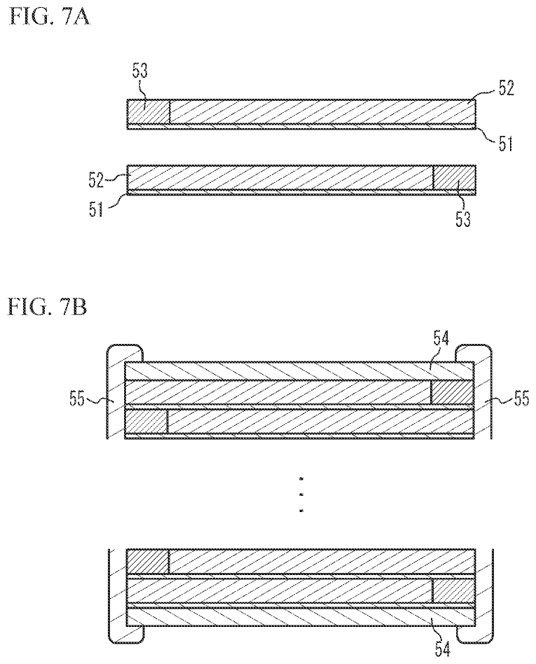

(Stacking process) As illustrated in FIG. 7A, an internal electrode paste 52 is printed on one side of the solid electrolyte green sheet 51. A reverse pattern 53 is printed on the peripheral area of the solid electrolyte green sheet 51 where the internal electrode paste 52 is not printed. The same material for the solid electrolyte green sheet 51 can be used as the reverse pattern 53. The solid electrolyte green sheet 51 after the printing can be used as a stack unit. The plurality of solid electrolyte green sheets 51 are stacked so as to be alternately shifted. As illustrated in FIG. 7B, a multilayer structure is obtained by pressing a cover sheet 54 from above and below in the stacking direction. In this case, in the multilayer structure, the internal electrode paste 52 for the positive electrode layer 10 is exposed on one end surface, and the internal electrode paste 52 for the negative electrode layer 20 is exposed on the other end surface. The cover sheet 54 can be formed by applying the raw material powder for the cover layer using a method similar to the making process of the solid electrolyte green sheet. The cover sheet 54 is formed thicker than the solid electrolyte green sheet 51. The thickness may be increased at the time of coating, or by stacking a plurality of coated sheets.

Next, an eternal electrode paste 55 is applied to two end faces of the multilayer structure by dipping or the like and is dried. Thus, a compact for forming the all solid battery 100a is obtained.

(Firing process) Next, the resulting ceramic multilayer structure is fired. The firing conditions are not particularly limited, such as under an oxidizing atmosphere or a non-oxidizing atmosphere, with a maximum temperature of preferably 400° C. to 1000° C., more preferably 500° C. to 900° C. In order to sufficiently remove the binder before the maximum temperature is reached, a step of maintaining the temperature lower than the maximum temperature in an oxidizing atmosphere may be provided. In order to reduce process costs, it is desirable to fire at as low a temperature as possible. After firing, re-oxidation treatment may be performed. Through the processes, the all solid battery 100a is formed.

By sequentially stacking the internal electrode paste, the current collector paste containing a conductive material, and the internal electrode paste, a current collector layer can be formed in the positive electrode layer 10 and the negative electrode layer 20 can be formed.

### EXAMPLES

(Examples 1 to 5) The electrode active material and the d electrolyte were highly dispersed using a bead mill to create a ceramic paste consisting only of ceramic particles. Carbon nanotubes were used as the conductive auxiliary agent. Since the carbon nanotubes were entangled, the carbon nanotubes were dispersed using an ultrasonic homogenizer or a wet jet mill using a paste solvent and an appropriate dispersant. The conditions of the dispersion treatment were adjusted so that the aspect ratio of the fiber diameter of the carbon nanotubes was 100:1 to 1000:1. An electrode paste was prepared by mixing ceramic paste, carbon nanotube dispersion, and binder. Thereafter, an electrode paste was printed on the solid electrolyte layer, stacked, and fired to form external electrodes to produce an all solid battery.

After sintering, the cross section of the battery was polished by ion milling, and SEM observation was performed to determine the thickness of the solid electrolyte layer, the average diameter and the area ratio of the conductive auxiliary agent contained in the electrode layer, and the area ratio of the electrode active material. The average diameter of the conductive auxiliary agent was determined by randomly measuring 300 short parts and taking the average value.

The average diameter of the conductive auxiliary agent in the electrode layer was 5 nm in Example 1, 15 nm in Example 2, 70 nm in Example 3, 130 nm in Example 4, and 2 nm in Example 5. The area ratio of the conductive auxiliary agent in the electrode layer was 0.7% in Example 1, 2.0% in Example 2, 5.0% in Example 3, 5.0% in Example 4, and 0.5% in Example 5. The thickness of the solid electrolyte layer was 20 μm in all of Examples 1 to 4, and 5 μm in Example 5. The area ratio of the electrode active material in the electrode layer was 28% in Example 1, 55% in Example 2, 79% in Example 3, 75% in Example 4, and 28% in Example 5.

(Comparative Example 1) In Comparative Example 1, the average cross-sectional diameter of the conductive auxiliary agent in the electrode layer was 130 nm, the area ratio of the conductive auxiliary agent in the electrode layer was 0.4%, the thickness of the solid electrolyte layer was 20 μm, and the area ratio of the electrode active material in the electrode layer was 28%.

(Comparative Example 2) In Comparative Example 2, the average cross-sectional diameter of the conductive auxiliary agent in the electrode layer was 130 nm, the area ratio of the conductive auxiliary agent in the electrode layer was 5.0%, the thickness of the solid electrolyte layer was 4 μm, and the area ratio of the electrode active material in the electrode layer was 28%.

(Comparative Example 3) In Comparative Example 3, the average cross-sectional diameter of the conductive auxiliary agent in the electrode layer was 150 nm, the area ratio of the conductive auxiliary agent in the electrode layer was 5.0%, the thickness of the solid electrolyte layer is 20 μm, and the area ratio of the electrode active material in the electrode layer was 28%.

(Comparative Example 4) In Comparative Example 4, the average cross-sectional diameter of the conductive auxiliary agent in the electrode layer was 130 nm, the area ratio of the conductive auxiliary agent in the electrode layer was 5.0%, the thickness of the solid electrolyte layer was 25 μm, and the area ratio of the electrode active material in the electrode layer was 28%.

(Evaluation of battery characteristics) Battery characteristics were evaluated for each of Examples 1 to 5 and Comparative Examples 1 to 4. The battery characteristics were evaluated by CC charging/discharging measurements at 25° C. (charging current 0.2C-discharge current 0.2C or charging current 1C-discharge current 1C, cut voltage upper limit 3.6V, lower limit 1.5V). For rate characteristics, the ratio of 1C discharge capacity when 0.2C discharge capacity was 100% was calculated. If the ratio was 70% or more, it was judged as very good “o”. If the ratio was 60% or more, it was judged as good “A”. If the ratio was less than 60%, it was judged as bad “x”. Capacity values were compared based on 0.2C discharge capacity. The ratio of the discharge capacity value of each battery was determined, on a presumption that the discharge capacity of Example 2 was taken as 100%. When the ratio was 90% or more, it was judged as very good “o”. When the ratio was less 80% or more, it was determined as good “Δ”. When the ratio was less than 80%, it was judged as bad “x”.

(Short rate) Furthermore, for each of Examples 1 to 5 and Comparative Examples 1 to 4, the short rate (ratio of the number of samples in which short circuits occurred) of 200 samples was measured. When the short-circuit rate was 5% or less, it was judged as good “o”, and when the short-circuit rate exceeded 5%, it was judged as bad “x”.

(Overall judgment) If both the rate characteristic and the capacity value were judged as very good “o” or good “Δ”, and at least one of them was judged as good “o”, and the short rate was judged as good “o”, the overall evaluation was judged as Good “o”. If the conditions for good “o” were not satisfied in the overall judgment, the overall judgment was judged as bad “x”. The results are shown in Table 1.

TABLE 1

| | CONDUCTIVE | | | AREA | | | |
|---|---|---|---|---|---|---|---|
| | AUXILIARY | | THICKNESS | RATIO | | | |
| | AGENT | | OF | OF | | | |
| | AVERAGE | AREA | ELECTROLYTE | ACTIVE | | | |
| | DIAMETER | RATIO | LAYER | MATERIAL | RATE | | SHORT |
| | (nm) | (%) | (μm) | (%) | CHARACTERISTICS | CAPACITY | RATE |
| EXAMPLE 1 | 5 | 0.7 | 20 | 28 | ∘ | Δ | ∘ |
| EXAMPLE 2 | 15 | 2.0 | 20 | 55 | ∘ | ∘ | ∘ |
| EXAMPLE 3 | 70 | 5.0 | 20 | 79 | ∘ | ∘ | ∘ |
| EXAMPLE 4 | 130 | 5.0 | 20 | 75 | ∘ | ∘ | ∘ |
| EXAMPLE 5 | 2 | 0.5 | 5 | 28 | ∘ | Δ | ∘ |
| COMPARATIVE | 130 | 0.4 | 20 | 28 | x | x | — |
| EXAMPLE 1 | | | | | | | |
| COMPARATIVE | 130 | 5.0 | 4 | 28 | — | — | x |
| EXAMPLE 2 | | | | | | | |
| COMPARATIVE | 150 | 5.0 | 20 | 28 | — | — | x |
| EXAMPLE 3 | | | | | | | |
| COMPARATIVE | 130 | 5.0 | 25 | 28 | Δ | Δ | ∘ |
| EXAMPLE 4 | | | | | | | |

In Examples 1 to 5, the overall evaluation was judged as good “o”. It is thought that this was because that in the cross section of the electrode layer, the average diameter of the conductive auxiliary agent was 2 nm or more and less than 150 nm, the proportion occupied by the electrode active material was 28% or more and less than 80%, and the area ratio occupied by the conductive auxiliary agent was 0.5% or more and 5% or less, and the solid electrolyte layer had a thickness of 5 μm or more and 20 μm or less.

In Comparative Example 1, the rate characteristics were judged as bad “x”. This is considered to be because the area ratio of the conductive auxiliary agent in the electrode layer was low, resulting in low conductivity within the electrode layer. In Comparative Example 2, the short-circuit rate was judged as bad “x”. This is thought to be because the solid electrolyte layer was thin, making short circuits more likely to occur. In Comparative Example 3 as well, the short-circuit rate was judged as bad “x.” This is thought to be because the conductive auxiliary agent was thick and hard, and the solid electrolyte layer was pierced. In Comparative Example 4, although the short-circuit rate was judged as good “o”, the rate characteristics and capacity were not judged as good “o”. This is considered to be because although the short rate was lower due to the thick solid electrolyte layer, it was disadvantageous in terms of capacity value and rate characteristics.

(Example 6) The electrode active material and the solid electrolyte were highly dispersed using a bead mill to create a ceramic paste consisting only of ceramic particles. Multilayer carbon nanotubes were used as the conductive auxiliary agent. Since multilayer carbon nanotubes were entangled, they were dispersed using an ultrasonic homogenizer or a wet jet mill using a paste solvent and an appropriate dispersant. The conditions of the dispersion treatment were adjusted so that the aspect ratio of the fiber diameter of the carbon nanotubes was 100:1 to 1000:1. An electrode paste was prepared by mixing ceramic paste, carbon nanotube dispersion, and binder. Thereafter, an electrode paste was printed on the solid electrolyte green sheet, stacked, and fired to form external electrodes to produce an all solid battery. In Example 6, carbon nanotubes with a GD ratio of 1.9 were used. Note that a Raman spectrometer (NRS-3300, manufactured by JASCO Corporation) was used to measure the GD ratio.

The cross section of the battery after sintering was polished by ion milling, and SEM observation was performed to determine the average diameter and the area ratio of each carbon nanotube contained in the electrode layer. In each electrode layer after firing, the average diameter of carbon nanotubes was 15 nm, and the area ratio of the carbon nanotubes was 1%. Moreover, the thickness of the solid electrolyte layer after firing was 20 μm.

(Example 7) In Example 7, carbon nanotubes with a GD ratio of 4 were used. In each electrode layer after firing, the average diameter of carbon nanotubes was 70 nm, and the area ratio of the carbon nanotubes was 1%. Moreover, the thickness of the solid electrolyte layer after firing was 20 μm.

(Example 8) In Example 8, carbon nanotubes with a GD ratio of 4 were used. In each electrode layer after firing, the average diameter of carbon nanotubes was 70 nm, and the area ratio of the carbon nanotubes was 4%. Moreover, the thickness of the solid electrolyte layer after firing was 20 μm.

(Example 9) In Example 9, carbon nanotubes with a GD ratio of 4 were used. In each electrode layer after firing, the average diameter of carbon nanotubes was 70 nm, and the area ratio of the carbon nanotubes was 4%. Moreover, the thickness of the solid electrolyte layer after firing was 10 μm.

(Example 10) In Example 10, carbon nanotubes with a GD ratio of 15 were used. In each electrode layer after firing, the average diameter of carbon nanotubes was 130 nm, and the area ratio of the carbon nanotubes was 4%. Moreover, the thickness of the solid electrolyte layer after firing was 20 μm.

(Comparative Example 5) In Comparative Example 5, carbon nanotubes with a GD ratio of 4 were used. In each electrode layer after firing, the average diameter of carbon nanotubes was 70 nm, and the area ratio of the carbon nanotubes was 0.5%. Moreover, the thickness of the solid electrolyte layer after firing was 20 μm.

(Comparative Example 6) In Comparative Example 6, carbon nanotubes with a GD ratio of 15 were used. In each electrode layer after firing, the average diameter of carbon nanotubes was 130 nm, and the area ratio of the carbon nanotubes was 4%. Moreover, the thickness of the solid electrolyte layer after firing was 4 μm.

(Comparative Example 7) In Comparative Example 7, carbon nanotubes with a GD ratio of 15 were used. In each electrode layer after firing, the average diameter of carbon nanotubes was 150 nm, and the area ratio of the carbon nanotubes was 4%. Moreover, the thickness of the solid electrolyte layer after firing was 20 μm.

(Comparative Example 8) In Comparative Example 8, carbon nanotubes with a GD ratio of 4 were used. In each electrode layer after firing, the average diameter of carbon nanotubes was 70 nm, and the area ratio of the carbon nanotubes was 4%. Moreover, the thickness of the solid electrolyte layer after firing was 25 μm.

(Evaluation of electrode resistance) Electrode resistance was measured for each of Examples 6 to 10 and Comparative Examples 5 to 8. The electrode resistance was measured by creating a sintered body containing only the electrode and using a DC resistance meter. If the electrode resistance was 2 Ω·cm or less, the electrode resistance was judged as good “o”. If the electrode resistance exceeded 2 Ω·cm, the electrode resistance was judged as bad “x”.

(Evaluation of rate characteristics) The rate characteristics were evaluated for each of Examples 6 to 10 and Comparative Examples 5 to 8. The rate characteristics were determined by performing CC charge/discharge measurements at 25° C. (charging/discharging current 0.2C or 1.0C, cutoff voltage upper limit 3.3V, lower limit 2.0V), and determining the 1C discharge capacity when 0.2C discharge capacity was treated as 100%. If the ratio was 70% or more, the rate characteristic was judged as good “o”. If the ratio was less than 70%, the rate characteristic was judged as bad “x”.

(Evaluation of battery capacity) Battery capacity was evaluated for each of Examples 6 to 10 and Comparative Examples 5 to 8. As the battery capacity, the capacity at 0.2C discharge at the time of rate characteristic measurement was used. The ratio of the discharge capacity values under each condition was determined when the battery capacity of Example 8 was taken as 100%. If the ratio was 90% or more, the battery capacity was determined as good “o”. If the ratio was less than 90%, the battery capacity was judged as bad “x”.

(Evaluation of short rate) The short ratio was evaluated for each of Examples 6 to 10 and Comparative Examples 5 to 8. The short circuit rate was measured by the number of short circuits among 50 samples. If the short rate was 5% or less, the short rate was judged as good “o”. If the short rate exceeded 5%, the short rate was determined as bad “x”.

(Overall judgment) If the electrode resistance, rate characteristics, capacity, and short-circuit rate were all judged as good “o”, the overall judgment was judged as good “o”. When any one of the electrode resistance, rate characteristics, capacity, and short-circuit rate was judged as bad “x”, the overall judgement was judged as bad “x”. The results are shown in Table 2.

TABLE 2

| | CONDUCTIVE | | | | | | | | |
|---|---|---|---|---|---|---|---|---|---|
| | AUXILIARY | | | THICKNESS | | | | | |
| | AGENT | | | OF | | | | | |
| | AVERAGE | AREA | | ELECTROLYTE | | | | | |
| | DIAMETER | RATIO | GD | LAYER | ELECTRODE | RATE | | SHORT | OVERALL |
| | (nm) | (%) | RATIO | (μm) | RESISTANCE | CHARACTERISTICS | CAPACITY | RATE | JUDGE |
| EXAMPLE 6 | 15 | 1 | 1.9 | 20 | ∘ | ∘ | ∘ | ∘ | ∘ |
| EXAMPLE 7 | 70 | 1 | 4 | 20 | ∘ | ∘ | ∘ | ∘ | ∘ |
| EXAMPLE 8 | 70 | 4 | 4 | 20 | ∘ | ∘ | ∘ | ∘ | ∘ |
| EXAMPLE 9 | 70 | 4 | 4 | 10 | ∘ | ∘ | ∘ | ∘ | ∘ |
| EXAMPLE 10 | 130 | 4 | 15 | 20 | ∘ | ∘ | ∘ | ∘ | ∘ |
| COMPARATIVE | 70 | 0.5 | 4 | 20 | x | x | x | — | x |
| EXAMPLE 5 | | | | | | | | | |
| COMPARATIVE | 130 | 4 | 15 | 4 | ∘ | — | — | x | x |
| EXAMPLE 6 | | | | | | | | | |
| COMPARATIVE | 150 | 4 | 15 | 20 | ∘ | — | — | x | x |
| EXAMPLE 7 | | | | | | | | | |
| COMPARATIVE | 70 | 4 | 4 | 25 | ∘ | x | x | ∘ | x |
| EXAMPLE 8 | | | | | | | | | |

In all of Examples 6 to 10, the overall judgement was judged as good “o”. It is thought that this was because the GD ratio of the conductive agent was 0.5 or more and 20 or less, the average diameter of the conductive auxiliary agent was 5 nm or more and less than 150 nm in the cross section of the electrode layer, and the area ratio of the conductive auxiliary agent in the cross section of the electrode layer was more than 0.5% and 10% or less, and the solid electrolyte layer had a thickness of 5 μm or more and 20 μm or less.

In Comparative Example 5, it is thought that because the area ratio of the conductive auxiliary agent was low, the electrode resistance increased and the rate characteristics and battery capacity deteriorated. In Comparative Example 6, it is thought that the short rate was high because the solid electrolyte layer was thin. In Comparative Example 7, it is thought that the short rate was high because the average diameter of the conductive auxiliary agent was large. In Comparative Example 8, it is considered that the rate characteristics deteriorated because the solid electrolyte layer was thick.

Although the embodiments of the present invention have been described in detail, it is to be understood that the various change, substitutions, and alterations could be made hereto without departing from the spirit and scope of the invention.

What is claimed is:

1. An all solid battery comprising:
a solid electrolyte layer; and
electrode layers that are provided on both main faces of the solid electrolyte layer and include an electrode active material and a fibrous conductive auxiliary agent,
wherein, in cross sections of the electrode layers, an average diameter of the conductive auxiliary agent is 2 nm or more and 150 nm or less, an area ratio occupied by the conductive auxiliary agent is 0.5% or more and 5.0% or less, and an area ratio occupied by the electrode active material is 28% or more and less than 80%, and
wherein a thickness of the solid electrolyte layer is 5 μm or more and 20 μm or less.

2. The all solid battery as claimed in claim 1, wherein the conductive auxiliary agent is a carbon material.

3. The all solid battery as claimed in claim 1, wherein the conductive auxiliary agent is a carbon nanotube.

4. The all solid battery as claimed in claim 1, wherein the solid electrolyte layer is an oxide material.

5. The all solid battery as claimed in claim 1, wherein a total length of the conductive auxiliary agent is 5 μm or more.

6. An all solid battery comprising:
a solid electrolyte layer; and
electrode layers that are provided on both main faces of the solid electrolyte layer and include an electrode active material and a carbon-based conductive auxiliary agent,
wherein, in cross sections of the electrode layers, an average diameter of the conductive auxiliary agent is 5 nm or more and less than 150 nm, and a GD ratio of the conductive auxiliary agent is 0.5 or more and 20 or less,
wherein, in the cross sections, an area ratio occupied by the conductive auxiliary agent is more than 0.5% and 10% or less, and
wherein a thickness of the solid electrolyte layer is 5 μm or more and 20 μm or less.

7. The all solid battery as claimed in claim 6, wherein the conductive auxiliary agent is a fibrous conductive auxiliary agent.

8. The all solid battery as claimed in claim 6, wherein the conductive auxiliary agent is a carbon nanotube.

9. The all solid battery as claimed in claim 6, wherein the conductive auxiliary agent is a multilayer carbon nanotube.

10. The all solid battery as claimed in claim 6, wherein the solid electrode layer is an oxide material.

11. The all solid battery as claimed in claim 6, wherein the solid electrode layer is a phosphate oxide material.

12. The all solid battery as claimed in claim 6, wherein the solid electrolyte layer and the electrode layers have a sintered body.
